(19) United States
(12) Patent Application Publication
(10) Pub. No.: US 2006/0068760 A1
(43) Pub. Date: Mar. 30, 2006

(54) System and method for pairing dual mode wired/wireless devices

(76) Inventors: Muhammad Farooq Hameed, San Diego, CA (US); Brian Jason Tietz, San Diego, CA (US); Ashok Kapur, Frederick, MD (US); Victor G. Zhodzishsky, North Potomac, MD (US)

Correspondence Address: CHRISTIE, PARKER & HALE, LLP, PO BOX 7068, PASADENA, CA, 91109-7068, US

(21) Appl. No.: 10/930,982

(22) Filed: Aug. 31, 2004

(51) Int. Cl. H04L 12/58

(52) U.S. Cl. 455/412.1; 455/41.1

(57) ABSTRACT

A method and apparatus for establishing wireless communication between a first and a second dual mode device, each dual mode device having a wired communication interface and a wireless communication interface. A wired connection between the first dual mode device and the second dual mode device is established via the wired communication interfaces. The second dual mode device is detected by the first dual mode device and a link key is created. The link key and the first device address are transferred to the second device via the wired connection and the second device address is retrieved via the wired connection by the first device. A wireless link is then established.

### FIELD OF THE INVENTION

The present invention relates generally to wireless devices; and more particularly to establishing a communication link to dual mode wired/wireless devices.

### BACKGROUND OF THE INVENTION

Wireless communication is rapidly growing. For example, peripheral devices and human interface devices (HIDs) are increasingly utilizing wireless communication to communicate with a host computer. Bluetooth (BT) is a wireless protocol and for security it depends on establishing a shared secret (called a link key) between two BT devices/systems. BT protocol uses the link key for authentication, deriving an encryption key from the link key, and using the encryption key to encrypt the information transmitted over the air. The BT link key is typically established via a BT “pairing” process defined in the BT specification. This process involves setting up a BT connection between two BT devices/systems, entering an identical PIN code on both sides, and using the PIN code to derive a shared secret link key.

In addition, BT devices/systems can remember the BT address and link keys of other BT devices/systems with which they have been connected before and use this information to quickly recreate a secure connection. The process by which BT devices/systems discover other BT devices/systems, connect to them, establish a link key and then store the Bluetooth device (BD) address and link key for future use, is referred to in the following discussion as the BT pairing process. A description of this process is part of the BT specification.

However, wireless HIDs, being essential for the operation of a computer for the first time, suffer from first boot and recovery problems. For example, in a typical first boot problem, a BT device does not initially know which computer (device address) it needs to connect to. Similarly, in a recovery case, if an existing BT device needs to be replaced, the replacing BT device does not initially know which computer (device address) it needs to plug into. One conventional solution is to store the host computer device address in the BT device at the time of manufacturing. However, this solution lacks flexibility and does not address the device replacement recovery case.

BT devices also suffer from a complicated pairing scheme. Current BT pairing requires a user to search for BT devices, locate the correct device from a list and enter a PIN code to complete the pairing. This process suffers from the following problems:
The device has to be discovered (which takes time).
The user must identify the device from a (potentially large) list of devices.
The user must read the PIN code from one device and enter it in the other device, or the user must enter the same PIN code on both devices. This takes time, it is error prone. Also, in the first boot scenario, the PIN code presentation is problematic.
A small PIN code leaves the user open to a brute force attack. The creation of the secret key depends on the entered PIN code and the size of the PIN code determines the number of possible link keys that can be generated. Most current systems use a 7 digit PIN which provides for only 10 million (that is, 107) combinations. A brute force attack on a BT traffic trace can quickly evaluate 10 million combinations and determine what the actual link key is.

Therefore, there is a need for a method and system to avoid the first boot and recovery problems and simplify the pairing scheme for wireless devices.

### SUMMARY OF THE INVENTION

The present invention provides an improved method and system for establishing wireless communication between two dual mode devices.

In one embodiment the present invention is a method for establishing secure wireless communication between a first and a second dual mode device, each dual mode device having a wired communication interface and a wireless communication interface. The method includes establishing a wired connection between the first dual mode device and the second dual mode device via the wired communication interfaces; detecting the second dual mode device by the first dual mode device; creating a link key; transferring the link key and a first device address to the second device via the wired connection; retrieving a second device address via the wired connection by the first device; and establishing a wireless link. In one embodiment the wireless communication interfaces are Bluetooth interfaces and the wired communication interfaces are universal serial bus (USB) interfaces.

In one embodiment the present invention is a method for pairing a computer and a dual mode device having a wired communication interface and a wireless communication interface. The method includes establishing a wired connection between the computer and the dual mode device via the wired communication interface; detecting the connected dual mode device; generating a link key; communicating the link key and an address of the computer to the dual mode device via the wired connection; receiving a device address via the wired connection; and establishing a wireless communication between the computer and the dual mode device.

In one embodiment the present invention is a system for establishing secure wireless communication. The system includes a first dual mode device including a computer controlled first wired communication interface and a computer controlled first wireless communication interface; and a second dual mode device including a computer controlled second wired communication interface and a computer controlled second wireless communication interface. The first wired communication interface detects the second dual mode device, establishes a wired connection between the first dual mode device and the second dual mode device with the second wired communication interface transmits a generated link key and a first device address to the second device, and retrieves a second device address via the wired connection. The first wireless communication interface and the second wireless communication interface establish a secured wireless link responsive to the generated link key and the first and second device addresses.

### BRIEF DESCRIPTION OF THE DRAWINGS

FIG. 1 is an exemplary block diagram of a system for firmware debugging of a wireless device;

FIG. 2 illustrates an architecture of Bluetooth wireless communication protocol;

FIG. 3 shows a Bluetooth protocol stack;

FIG. 4 depicts an exemplary scenario for the RFCOMM in the Bluetooth system to emulate a serial port;

FIG. 5 depicts example profiles of Bluetooth protocol stacks for executing firmware debugging, according to one embodiment of the present invention;

FIG. 6 is an exemplary sequence diagram for first boot and device replacement, according to one embodiment of the present invention;

FIG. 7 is an exemplary sequence diagram for USB HID emulation (UHE) use, according to one embodiment of the present invention;

FIG. 8 is an exemplary sequence diagram for Bluetooth operation under stack control, according to one embodiment of the present invention; and

FIG. 9 is an exemplary process flow for BT pairing between a dual mode BT/USB device and a computer, according to one embodiment of the present invention.

### DETAILED DESCRIPTION

In one embodiment, the present invention is a method and system for pairing of a first dual mode device (for example, a personal computer) and a second dual mode device (for example, a keyboard). A request for pairing the second dual mode device is generated by the first dual mode device over a wired connection. The first dual mode device then generates a link key and stores the link key and the BD address of the second dual mode device. The first dual mode device communicates its own BD address and the generated link key to the second dual mode device over the wired connection.

The second dual mode device receives the BD address for the first dual mode device and the generated link key and stores them locally. A wireless link can then be established based on the exchanged respective BD addresses of the two devices and the link key. The two devices can then authenticate each other either over the wired link or the wireless link.

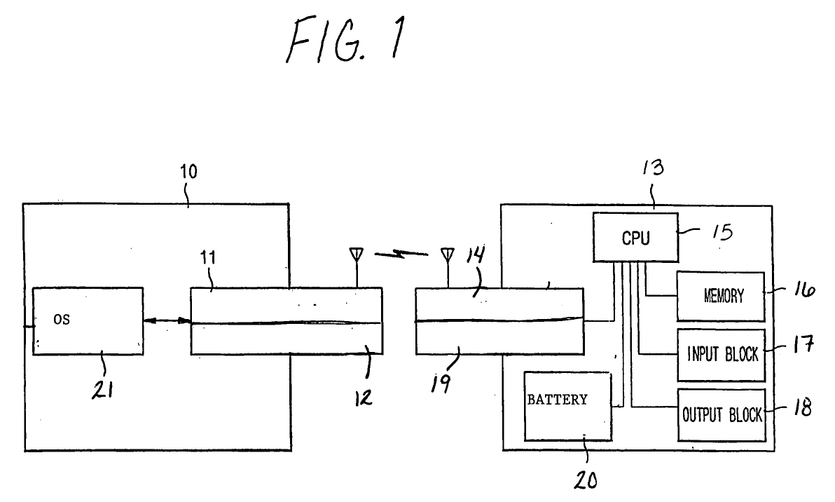

In one embodiment, the wireless link is a Bluetooth protocol and the wired link is a universal serial bus (USB) interface. FIG. 1 is a block diagram of a system for establishing a communication link to a dual mode USB/BT device 13. A computer (system) 10 includes a wireless communication interface 11, for example a Bluetooth (BT) communication interface, for executing wireless communication and a wired interface 12 such as a USB, RS 232, I²C, PS2, and the like for transmitting and receiving data between computer 10 and dual mode device 13. Computer 10 also includes an operating system (OS) 21. In one embodiment, wireless communication interface 11 is a BT transceiver that plugs into computer 10 and thus making computer 10 Bluetooth capable.

Dual mode device 13 also includes a wireless communication interface 14 and a wired interface 19 for receiving and transmitting data from/to computer 10. Device 13 also includes a CPU 15, a memory 16, an input block 17, and an output block 18. Memory 16 may include a ROM for storing firmware executed by the CPU, a RAM for storing information, and a non-volatile memory for storing link key, BD addresses PIN, and the like. Device 13 also includes a battery 20 that is preferably re-chargeable. The battery may be charged via the wired connection. Wireless communication interface 14 and wired interface 19 are coupled to CPU 15 and transmit data to OS 21 for execution on computer 10. The dual mode device maybe a dual mode keyboard, mouse, printer, other dual mode peripherals, or any other dual mode digital device.

In one embodiment, the wired interface is a USB interface. Digital devices are increasing supporting USB ports. Typically, in a computer system having USB ports, a USB master controller (e.g., software or firmware) is virtualized and embedded in an OS. Serial or parallel ports or headers and/or proprietary modules have typically been integrated into digital devices with USB ports to allow for serial communication with other USB enabled devices. Typically, a USB bus serves as an external interface serial bus between the USB enabled computer 10 and the device 13.

In wireless operation, CPU 15 receives a communication channel allocation-request signal transmitted from computer 10 via the wireless communication interface 11, and then judges if the wireless communication can be established in the current condition of CPU 15. If the wireless communication is established, CPU 15 transmits a message allowing wireless access.

In one embodiment, computer 10 and device 13 use Bluetooth protocol to wirelessly communicate with each other, after the pairing is accomplished. To establish a Bluetooth wireless communication link, a first radio transceiver (for example, BT interface 14) associated with the computer 10, and a second radio transceiver (for example, BT interface 11) associated with device 13 are configured to automatically find and contact each other to establish a wireless communication link upon being brought into proximity with each other. Typically, systems utilizing the Bluetooth communication protocol transmit a general inquiry (or in some cases, a limited inquiry), which is received and acknowledged by similarly configured devices located within receiving range, using a preferred communication format. Once a second Bluetooth configured device is identified, a link is established and authenticated.

Establishing a Bluetooth link authentication requires the initiating Bluetooth system to check to see if a link between the two communicating devices has already been previously established. If a link has been previously established, the authentication is automatically accepted by the initiating Bluetooth device. For the first time only that two devices communicate, an initialization procedure is needed to create a common link key in a safe manner. This initialization procedure is called pairing. The method and system of the present invention utilizes a wired connection such as, a USB, RS 232, I²C, PS2, and the like to accomplish a quick and efficient pairing of two dual mode devices. Once the pairing is accomplished, the two dual mode devices are initialized and ready to wirelessly communicate with each other.

Typically, an authentication procedure first checks to see if a link between the two devices has been already authenticated. If so, the authentication is confirmed. If the link between the two devices is not currently authenticated but a common link key exists between the two devices (from a previous link), the authentication procedure re-authenticates the link. If the re-authentication fails, or if there are no common link keys available between the two devices, the authentication procedure initiates the pairing procedure to generate a new set of link keys between the two devices. Successful completion of the pairing procedure results in the establishment of an authenticated link between the two devices. A complete description of the Bluetooth authentication procedures may be found in the “Specification of the Bluetooth System,” Version 1.2, published Nov. 5, 2003, the relevant contents of which are hereby expressly incorporated by reference.

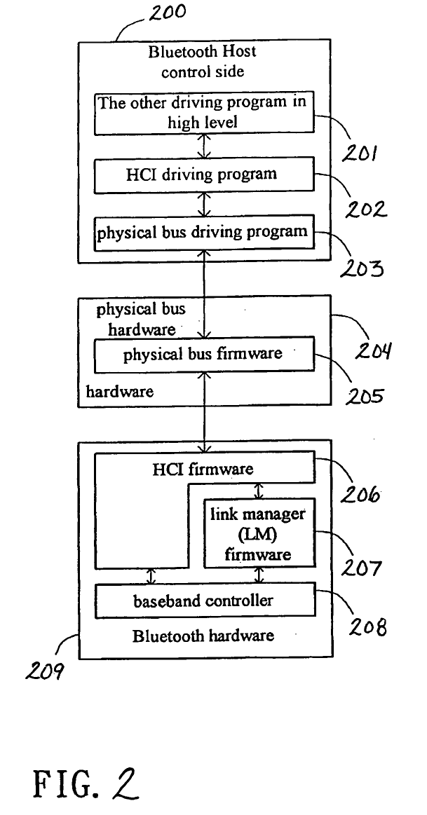

FIG. 2 illustrates an architecture of Bluetooth wireless communication protocol. A physical bus hardware 204 connects the Bluetooth host 200 and the Bluetooth hardware 209. The structure of the Bluetooth hardware 209 includes a baseband controller 208, a host controller interface (HCI) firmware 206, and a link manager (LM) firmware 207. During the wireless transmission, the host controller interface firmware 206 encodes the received data into a format of HCI packet, and the HCI packet is further fed into the Bluetooth host 200 via a physical bus firmware 205. Different functions can be performed under the Bluetooth system, after the HCI packet has been sequentially processed by a physical bus driving program 203, the HCI driving program 202 and other driving program 201.

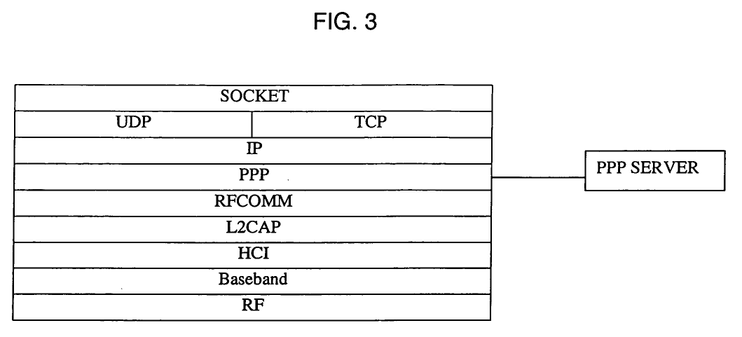

FIG. 3 shows a Bluetooth protocol stack constructed hierarchically from the bottom layer in order of radio frequency (RF), baseband, host controller interface (HCI), logical link control and adaptation protocol (L2CAP), RFCOMM, point-to-point protocol (PPP), Internet Protocol (IP), transmission control protocol (TCP)/user datagram protocol (UDP), and socket.

The RF layer corresponds to the physical layer of the Open Systems Interconnection (OSI) framework. Similar to the RF layer, the baseband layer corresponds to the physical layer that establishes a physical connection. The HCI layer is an interfacing protocol between a Bluetooth module and a host. The L2CAP layer corresponds to the data link layer of the OSI, and is a protocol stack for interfacing a lower layer protocol stack with an upper layer application. The L2CAP layer has a similar role as the TCP layer of the Internet Protocol (IP) and is located above the HCI layer for enabling the upper layer protocol or application for exchanging data packets.

The RFCOMM layer is an emulator for serial communications and a protocol replacing serial communication protocols such as, a USB, RS 232, I²C, PS2, and the like. For instance, USB is a wired protocol and security of USB operation is guaranteed by the physical wire which connects the device to the system.

The PPP layer is a protocol for serial communication between two computers. IP is an Internet communication protocol. TCP is a protocol used with IP for transmitting data in a message form on the Internet. UDP is a communication protocol providing limited services when messages are communicated using IP. UDP is an alternative to TCP, and when used with IP, is also referred to as UDP/IP.

Similar to the TCP, the UDP uses the IP to enable a computer to receive an actual data unit (datagram) from the another computer. A socket is a communication method between a client program and a server program on a network. The socket is sometimes referred to as an application programming interface (API) and is generated and utilized by a series of programming requests or function calls.

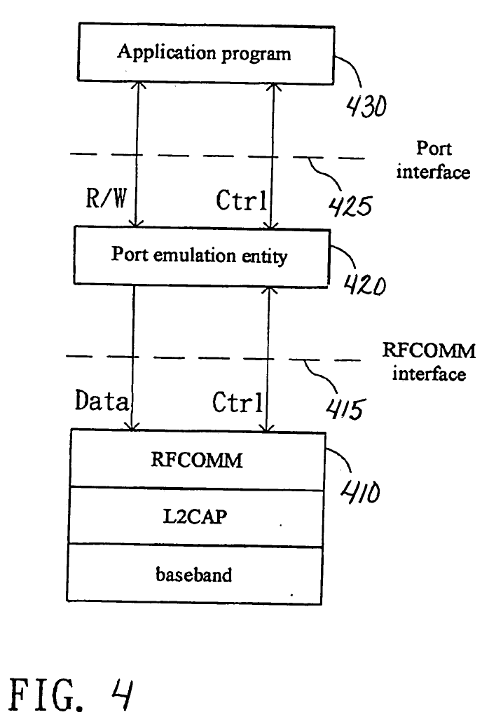

FIG. 4 depicts an exemplary scenario for the RFCOMM in the Bluetooth system to emulate a serial port, for example, a USB interface. The wireless communication interface 14 of device 13 in FIG. 1, includes RFCOMM transmission device 410 that can use the port emulation entity 420 to transmit the data to computer 10. The RFCOMM transmission device 410 can use the RFCOMM interface 415 and the port emulation entity 420 for transmitting the data. The control signal between the two elements can be used to set the usual control parameters and the port parameters. Additionally, the port emulation entity 420 is capable of performing reading, writing, and control functions by utilizing the port interface 425.

In Bluetooth terminology, bonding is a dedicated procedure for performing the first authentication between BT devices, where a common link key is created and stored for future use. An unknown device is a Bluetooth device for which no information (BD address, link key, PIN, or other) is stored. Prior to bonding, the host computer, the wireless keyboard, and the wireless mouse are unknown to one another. In this state, the devices are not yet bonded and are unknown to one another. A known device is a BT device for which at least the BD address (BD_ADDR) is stored. During setup, the host computer will learn the BD_ADDR of the wireless keyboard and the wireless mouse. Both the host computer and the host-side wireless interface may store the BD_ADDR of each serviced wireless interface device, i.e., wireless keyboard, wireless mouse, camera, printer, game controller, etc. as well as additional information relating to the bonding of the devices.

An authenticated device is a BT device whose identity has been verified during the lifetime of the current link, based on the authentication procedure. For example, a wireless keyboard is typically authenticated by the host computer after every connection. A trusted relationship is created when a remote device is marked as a trusted device. This includes storing a common link key for future authentication. During the setup procedure, the wireless keyboard may be marked as a trusted device.

After the setup procedure has been completed, the link key, the BD_ADDR (which is based upon the COD of the wireless keyboard), and other configuration information are stored in a non-volatile memory of the host-side wireless interface. The wireless keyboard also saves host information and link key information into its (non-volatile) memory. Additionally, the host-side wireless interface saves the configuration information of the wireless keyboard in its (non-volatile) memory for subsequent use.

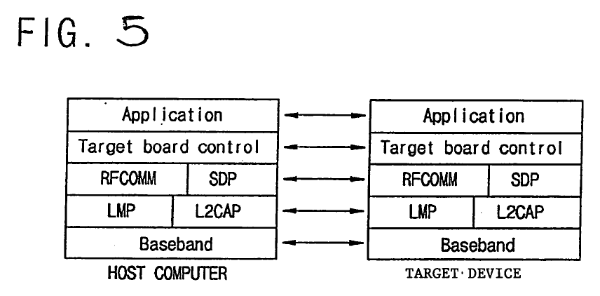

FIG. 5 depicts example profiles of Bluetooth protocol stacks for executing the pairing process between two dual mode devices, according to one embodiment of the present invention. Bluetooth protocol stacks such as the HCI, the L2CAP and the RFCOMM and the profiles may respectively be realized inside the device drivers, the kernel and the like of the computer 10 as well as, the application program, and the like of the device 13.

Dual mode devices, for example dual mode HIDs, can function without any special host support. Minimally, to use the BT mode, the host needs to be BT aware and have a BT transceiver which is under Bluetooth stack control at the operating system login prompt. The wired mode of operation is functional in the absence of a Bluetooth stack or transceiver, facilitating use of such devices as high-end USB HIDs for which the user has the option to later install a Bluetooth stack and use the HID unconstrained by wires. The host then eliminates the need for BT pairing.

In operation, when a wired HID is plugged in or detected by the system, BT capability is determined. This can be done via a wired HID report descriptor for the BT pairing feature report. If the HID is recognized as a dual mode device, the host creates a cryptographically random link key and passes it to the device. The host also queries the HID for its BD_ADDR and saves the BD_ADDR internally along with the link key. The host also loads any necessary BT HID drivers at this time.

If boot mode operation over BT (for example, USB HID emulation described below) is desired and the host has a UHE capable transceiver, the HID's BD_ADDR and link key should also be provided to the transceiver at this time.

Pairing a Bluetooth HID device with a Bluetooth stack over the HID's wired connection should preferably be restricted to times when the user is logged in, because being logged in is considered a secure context. A user who has plugged in the dual mode HID can be reasonably assumed to be the user who was authenticated by username/password entry at the login prompt.

While it is possible for a user to leave a machine unattended in a logged in state, that act itself would have already compromised the system's security. The user can also be prompted for a password before committing the BT pairing to guard against the possibility of the user leaving the machine unattended. If the Bluetooth stack is paired only with a Bluetooth HID over a wired connection when in a secure context, a subsequently established and authenticated (using the link key) BT link is secured and can be safely used to entered sensitive information, for example, entering a password at the prompt.

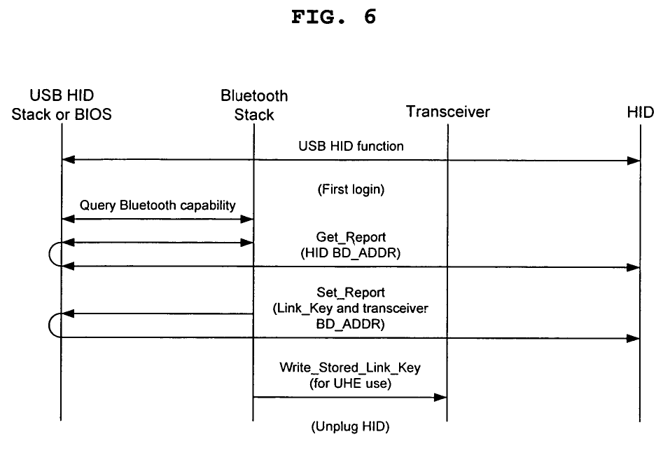

FIG. 6 is an exemplary sequence diagram for first boot and device replacement, according to one embodiment of the present invention. As shown, during a first boot and/or recovery, the user plugs in the HID through the USB connection and uses the HID as a USB HID device. This allows the user to go through BIOS operations, OS initialization, user login, and any other operations that may be necessary for booting and/or recovery.

Once the OS loads, the OS (or a driver) queries the HID via the USB connection and determines that the device is a dual mode USB/BT HID. The OS then retrieves the BD address of the HID via a USB “Get_Report” operation, generates a random number for use as the BT link key, and stores it along with the BD address of the host (or the BT transceiver of the host) via a “Set_Report” on the HID. The HID now knows which BD address to connect to during BT operation. The random key may optionally be encrypted for better security.

The OS also saves the HID BD address along with the link key generated internally. These will be used for authentication during reconnection with the HID. The OS optionally provides the HID BD address and link key to the host BT transceiver. This allows UHE functionality on a UHE capable transceiver.

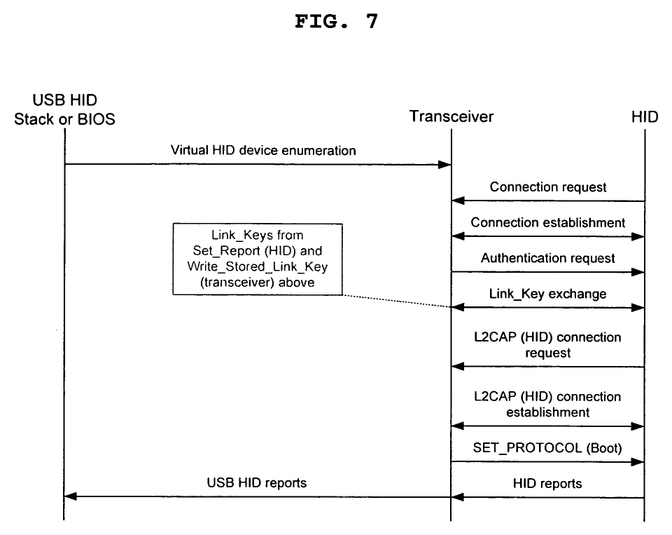

FIG. 7 is an exemplary sequence diagram for USB HID emulation (UHE) use, according to one embodiment of the present invention. As shown, when the system comes up (for example, after reset, sleep, hibernation, etc.), a UHE capable transceiver pretends to be a USB keyboard and/or mouse. The BIOS/OS enumerates the virtual USB HID devices. During UHE operation, if the user uses a HID which is paired to a UHE capable host (or transceiver), the HID issues a connection request to the UHE capable transceiver. The transceiver sets up the connection and then requests authentication.

The HID and the transceiver complete authentication using the previously generated/programmed link key. The HID proceeds with setting up the HID control and interrupt channels. The UHE capable transceiver then places the HID in boot mode. The HID then starts issuing boot mode HID reports which are forwarded by the transceiver to host over the virtual HID ports.

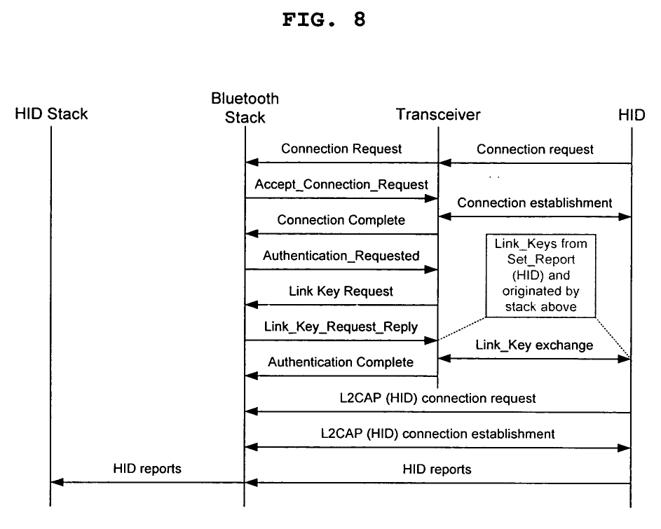

FIG. 8 is an exemplary sequence diagram for Bluetooth operation under stack control, according to one embodiment of the present invention. As shown, when the HID is not connected via the wired interface and the user attempts to use it (for example, move a mouse, press a key, etc.), the HID pages the host using the BD address of the host. The host accepts the connection and proceeds with authenticating the HID using the link key, as described above. The HID then sets up the HID control and interrupt channels and begins providing HID reports to the host via the BT link.

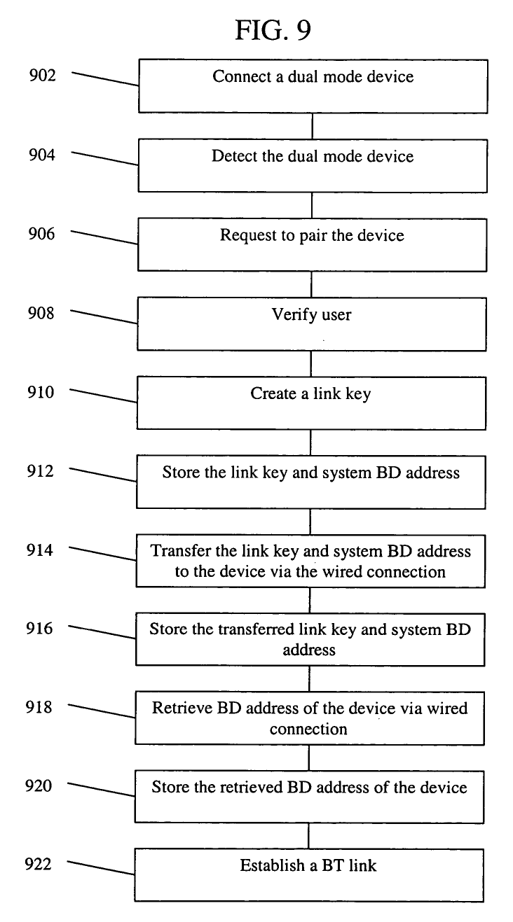

FIG. 9 is an exemplary process flow for BT pairing between a dual mode BT/USB device and a system (computer) which supports both USB and BT interfaces, according to one embodiment of the present invention. Although this exemplary embodiment uses Bluetooth and USB as examples of wireless and wired communication, the present invention is not limited to USB/BT devices. Other wireless and wired connections are also applicable to, and are within the scope of the present invention.

In this embodiment, the method and system of the present invention rely on the ability to create a secure wired connection between the device and the system by connecting them together via a USB interface and then pairing the device and the system together over the secure USB link. Note that the USB interface connecting the system to the device is not used as a BT USB transport.

In block 902, the dual mode USB/BT device is connected to a system (for example, a host computer) through the USB interface. Note that the device is acting as a wired USB device and not as a BT device, but the pairing which will be established over the non-BT transport USB interface is for BT use. For example, a dual mode USB/BT keyboard is connected via a USB cable to the USB port of a computer which supports both BT and USB interfaces. The keyboard in this situation acts like a normal USB keyboard.

In block 904, the OS on the system detects that a BT capable device is plugged into a USB port and prompts the user if he/she wants to (BT) pair the device to the system, as shown in block 906. The detection of the dual mode device can be done by for example, reading a report descriptor or an identifier of the device identifying the device as a dual mode device. Alternatively, the user manually requests the OS to (BT) pair the device. In one embodiment, the OS automatically initiates the pairing process.

Optionally, the OS prompts the user to verify himself/herself by entering his/her password, as depicted in block 908. This eliminates “Man in the Middle” attacks and other security holes. The Man in the Middle attack refers to an unauthorized person intercepting the communication link and pretending that he is the other end of the link. This includes sniffing, filtering, recording, or replaying the data.

At this point the OS creates a link key for use with the device, as depicted in block 910. This may be done entirely by the OS or may involve the BT controller on the system and/or the device.

In block 912, the OS stores the BD address of the system's BT controller along with the shared secret key on to the device. This is done by transferring the BD address and link key over the USB interface, as shown in block 914. The device then stores the link key and BD address of the system locally, as illustrated in block 916

The system also retrieves the BD address of the device via the wired connection, as depicted in block 918. In block 920, the system also stores the BD address of the device and the link key for future use. The OS may also write the HID's BD address and the shared secret link key to the system's BT controller. This permits USB HID Emulation (UHE) operation for HIDS. Preferably, the storage of the BT link key to the system's BT controller through the controller's BT transport is done using HCI commands. At this point, the device and the system are (BT) paired and a BT link between the device and the system is established, as shown in block 922.

Note that the operations of FIGS. 6, 7, 8, and 9 are not limited to the sequence indicated by the numbering. In fact, these various operations could be performed in differing orders or concurrently with one another.

This scheme can be extended to pairing systems/devices X and Y which have both a wired interface and a wireless interface. Wireless pairing is accomplished by connecting the two systems X and Y together via the wired interface, creating and transferring link keys over the wire and saving the device address and link key on both systems/devices.

The BT pairing over a wired interface scheme of the present invention does not suffer from the problems experienced by the conventional BT pairing schemes, because the device is implicitly identified by plugging it in to the wired interface. Also, the time-consuming process of discovery and user identification of the device from a list is not required. Further, since there is no requirement for entering a PIN code, the method and system are useful for devices which do not have any means of entering a PIN code, e.g. a mouse or an audio headset. Additionally, a secure link key can be established for such devices, which is not possible when using conventional BT pairing procedures. At most, the user is requested to enter his/her password. Finally, a full length (128 bits for current BT implementations) random link key is established making it nearly impossible for an attacker (hacker) to discover the link key using a brute force attack, that is, trying all the combinations for the 128 bits of the link key.

It will be recognized by those skilled in the art that various modifications may be made to the illustrated and other embodiments of the invention described above, without departing from the broad inventive scope thereof. It will be understood therefore that the invention is not limited to the particular embodiments or arrangements disclosed, but is rather intended to cover any changes, adaptations or modifications which are within the scope and spirit of the invention as defined by the appended claims.

What is claimed is:

1. A method for establishing secure wireless communication between a first and a second dual mode device, each dual mode device having a wired communication interface and a wireless communication interface, the method comprising:
establishing a wired connection between the first dual mode device and the second dual mode device via the wired communication interfaces;
detecting the second dual mode device by the first dual mode device;
creating a link key;
transferring the link key and a first device address to the second device via the wired connection;
retrieving a second device address via the wired connection by the first device; and
establishing a wireless link.

2. The method of claim 1, wherein the wireless communication interfaces are Bluetooth interfaces.

3. The method of claim 1, wherein the wired communication interfaces are universal serial bus (USB) interfaces.

4. The method of claim 1, wherein the wired communication interfaces are RS 232 interfaces.

5. The method of claim 1, wherein the wired communication interfaces are PS2 interfaces.

6. The method of claim 1, further comprising prompting a user to request establishing the wireless communication.

7. The method of claim 6, further comprising authenticating the user.

8. The method of claim 7, wherein the authenticating the user comprises entering a password.

9. The method of claim 1, further comprising storing the link key in a memory at the first device.

10. The method of claim 1, further comprising storing the link key in a memory at the second device.

11. A system for establishing secure wireless communication between a first dual mode device and a second dual mode device, each dual mode device having a wired communication interface and a wireless communication interface comprising:
means for establishing a wired connection between the first dual mode device and the second dual mode device via the wired communication interfaces;
means for detecting the second dual mode device by the first dual mode device;
means for creating a link key;
means for transferring the link key and a first device address to the second device via the wired connection;
means for retrieving a second device address via the wired connection by the first device; and
means for establishing a wireless link.

12. The system of claim 11, wherein the wireless communication interfaces are Bluetooth interfaces.

13. The system of claim 11, wherein the wired communication interfaces are universal serial bus (USB) interfaces.

14. The system of claim 11, wherein the wired communication interfaces are RS 232 interfaces.

15. The system of claim 11, wherein the second dual mode device is a dual mode keyboard.

16. The system of claim 11, wherein the second dual mode device is a dual mode mouse.

17. The system of claim 16, further comprising means for authenticating the user.

18. The system of claim 17, wherein the means for authenticating the user comprises means for entering a password.

19. The system of claim 11, further comprising means for storing the link key in a memory at the first device.

20. The system of claim 11, further comprising means for storing the link key in a memory at the second device.

21. A method for pairing a computer and a dual mode device having a wired communication interface and a wireless communication interface, the method comprising:
establishing a wired connection between the computer and the dual mode device via the wired communication interface;
detecting the connected dual mode device;
generating a link key;
communicating the link key and an address of the computer to the dual mode device via the wired connection;
receiving a device address via the wired connection; and
establishing a wireless communication between the computer and the dual mode device.

22. The method of claim 21, wherein the wireless communication interfaces are Bluetooth interfaces.

23. The method of claim 21, wherein the wired communication interfaces are universal serial bus (USB) interfaces.

24. A system for establishing secure wireless communication comprising:
a first dual mode device including a computer controlled first wired communication interface and a computer controlled first wireless communication interface; and
a second dual mode device including a computer controlled second wired communication interface and a computer controlled second wireless communication interface, wherein the first wired communication interface detects the second dual mode device, establishes a wired connection between the first dual mode device and the second dual mode device with the second wired communication interface transmits a generated link key and a first device address to the second device, and retrieves a second device address via the wired connection, and wherein the first wireless communication interface and the second wireless communication interface establish a secured wireless link responsive to the generated link key and the first and second device addresses.

25. The system of claim 24, wherein the first and second wireless communication interfaces are Bluetooth interfaces.

26. The system of claim 24, wherein the first and second wired communication interfaces are universal serial bus (USB) interfaces.
